(19) United States
(12) Patent Application Publication
(10) Pub. No.: US 2006/0139144 A1
(43) Pub. Date: Jun. 29, 2006

(54) Temperature sensor, ceramic device, and method of making the same

(76) Inventors: William J. LaBarge, Bay City, MI (US); Richard F. Beckmeyer, Davisburg, MI (US)

Correspondence Address: Cantor Colburn, LLP, 55 Griffin Road South, Bloomfield, CT, 06002, US

(21) Appl. No.: 11/024,220

(22) Filed: Dec. 28, 2004

(51) Int. Cl. H01C 1/012

(52) U.S. Cl. 338/308

(57) ABSTRACT

A ceramic device comprises a substrate; a resistive element disposed on the substrate; and a protective coating disposed on the resistive element, wherein the protective coating comprises a M⁺³ metal oxide, a M⁺⁴ metal oxide, or a combination comprising at least one of the foregoing, and a phosphate.

### BACKGROUND

Increased demand for improved fuel economy and emissions control has necessitated the development of exhaust treatment components (e.g., catalytic converters, catalytic absorbers, diesel particulate traps, non-thermal plasma conversion devices, and the like) capable of reducing undesirable exhaust constituents (e.g., carbon monoxide (CO), hydrocarbons (HC), nitrogen oxides (NOx), and the like) over a wide range of air/fuel mixtures (e.g., in both fuel-rich and fuel-lean conditions). However, stricter emission regulations have lead to the use of exhaust treatment components comprising chemical elements that are not capable of being exposed to the high exhaust temperatures exhibited in the past, e.g., greater than or equal to about 900° C. Exhaust treatment components used in automotive exhaust environment are increasingly susceptible to failure at temperatures greater than or equal to about 700° C. Temperature sensors are frequently being incorporated into exhaust treatment systems such that measures to reduce exhaust temperatures can be initiated to protect these exhaust treatment components.

For example, planar temperature sensors are used in a wide variety of applications across many different disciplines. Generally, a planar temperature sensor can comprise a resistive element disposed on a ceramic substrate. In automotive applications, the resistive element can comprise a resistance value of greater than or equal to about 200 ohms, which can be achieved by creating an elongated narrow ribbon of resistive element material (e.g., platinum) comprising certain resistance characteristics. It is noted, however, that the resistive element can be poisoned by exhaust constituents (e.g., carbon monoxide) and/or various contaminants can collect on the resistive element, thereby affecting the resistance value of the resistive element. As such, planar temperature sensors can comprise a glass material layer disposed over the resistive element to prevent/mitigate poisoning of the resistive element.

However, at high temperatures, e.g., temperatures greater than or equal to 600° C., metal oxide cations can readily be transported through the glass material layer. It is noted that the metal oxide cations that migrate through the glass material layer can adversely affect the resistance of the resistive element. As an alternative to the glass material layer, a ceramic protective coating (layer), e.g., aluminum oxide, can be coated over the resistive element in an effort to prevent metal cations and other contaminants (e.g., sodium, calcium, magnesium, zinc, iron, copper, lead, chromium, manganese, molybdenum, vanadium, and the like) from migrating to the resistive element. In applying the ceramic protective coating (e.g., by plasma spraying), however, the protective coating can have a porosity that can allow various contaminants to still reach the resistive element. Therefore, what is needed in the art is a protective coating for a resistive element of a temperature sensor or other ceramic resistive device capable of reducing/eliminating metal cations and other contaminants from migrating to the resistive element.

### SUMMARY

Disclosed herein are temperature sensors, ceramic devices, and methods of making the same.

One embodiment of a ceramic device comprises a substrate; a resistive element disposed on the substrate; and a protective coating disposed on the resistive element, wherein the protective coating comprises a M⁺³ metal oxide, a M⁺⁴ metal oxide, or a combination comprising at least one of the foregoing and a phosphate.

Another embodiment of a ceramic device comprises a substrate; a resistive element disposed on the substrate; and a protective coating disposed on the resistive element, wherein the protective coating comprises a M⁺³ metal oxide, a M⁺⁴ metal oxide, or a combination comprising at least one of the foregoing, and a porosity-sealing component such that the protective coating comprises a porosity less than or equal to about 3.0%.

One embodiment of a method of making a ceramic device comprises forming a resistive element on a substrate; disposing a protective coating on the resistive element; and reducing a porosity of the protective coating by applying a phosphate to the protective coating.

The above-described and other features will be appreciated and understood by those skilled in the art from the following detailed description, drawings, and appended claims.

### DRAWINGS

Referring now to the figures, which are exemplary embodiments and wherein like elements are numbered alike:

FIG. 1 is a perspective schematic representation of one embodiment of a temperature sensor;

FIG. 2 is a perspective schematic representation of the resistive element of FIG. 1 after trimming;

FIG. 3 is a cross sectional view of an embodiment of a packaged temperature sensor; and

FIG. 4 is a graphical representation of the percent resistance shift as a function of time for an accelerated dynamometer test, as disclosed herein, for a temperature sensor with a protective coating and a temperature sensor with a protective coating comprising a porosity-sealing component.

### DETAILED DESCRIPTION

It should first be noted that the terms “first,” “second,” and the like herein do not denote any order or importance, but rather are used to distinguish one element from another, and the terms “a” and “an” herein do not denote a limitation of quantity, but rather denote the presence of at least one of the referenced item. Furthermore, all ranges disclosed herein are inclusive and combinable (e.g., ranges of “up to about 25 wt. %, with about 5 wt. % to about 20 wt. % desired, and about 10 wt. % to about 15 wt. % more desired,” is inclusive of the endpoints and all intermediate values of the ranges, e.g., “about 5 wt. % to about 25 wt. %, about 5 wt. % to about 15 wt. %” etc.).

This disclosure relates to a ceramic device (e.g., a temperature sensor, a heater, and the like) comprising a resistive element. More particularly, this disclosure relates to a protective coating disposed over the resistive element, wherein the protective coating can comprise a porosity-sealing component (e.g., a phosphate, and the like). While the ceramic device is discussed in relation to a temperature sensor for ease in discussion, it is to be understood that other devices comprising a resistive element are within the scope of this disclosure.

For example, displanar resistance temperature detectors (RTD) for use at high temperatures, i.e., temperatures greater than or equal to about 600° C., are discussed herein. By way of example, a rectangular temperature sensor is depicted in the figures that are described herein. However, the shape of the sensor can be any geometric shape or combination of geometric shapes and does not need to be rectangular to fall within the scope of the instant disclosure and the scope of the appended claims. It should also be noted, that although described in relation to sensing exhaust gas temperatures, e.g., for automotive applications, the temperature sensor can be applied in various areas desiring temperature sensing, including aerospace, industrial (e.g., in furnaces, flues, and the like), and elsewhere.

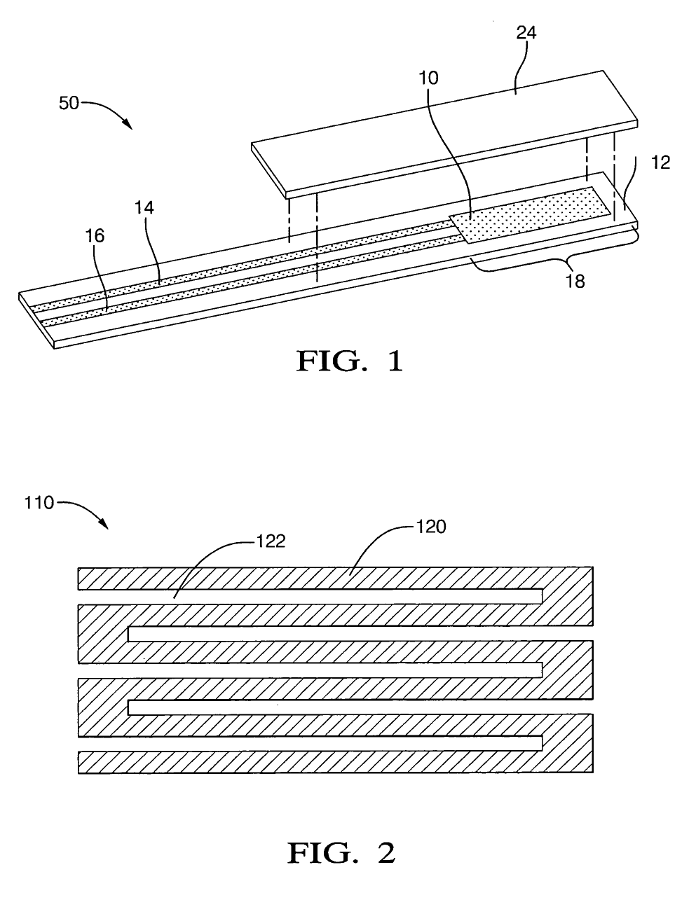

Referring now to FIG. 1, an exemplary temperature sensor generally designated 50 is illustrated. The temperature sensor 50 can comprise a resistive element 10 disposed on a substrate 12. Leads 14 and 16 can be disposed on the substrate 12 and can be in electrical communication with resistive element 10. In various embodiments, a protective coating 24 can be disposed over the resistive element 10 in the form of a cover plate. Generally, the temperature sensor 50 can comprise a sensing end 18 that can comprise resistive element 10. As will be discussed in greater detail, the resistive element 10 can be disposed on substrate 12 as a pad (shown in FIG. 1) and later trimmed (e.g., laser trimmed, and the like) for ablative removal of the resistive element material to reduce the resistive element cross-sectional area and obtain a desired resistance circuit (FIG. 2, resistive element 110).

FIG. 2 illustrates a resistive element 110 that has been trimmed. Generally, the resistive element 110 can comprise a margin(s) 120 and a trimmed portion 122. The trimmed portion 122 can comprise any pattern, e.g., a serpentine pattern (illustrated in FIG. 2), a spiral pattern, and the like. The resistive element pattern can be repeated over a mother substrate (not shown) such that many separate resistive element circuits can be formed on the mother substrate. After completion of the trimming, the mother substrate can be scribed (e.g., laser scribed, and the like) and divided up into individual temperature sensors (FIG. 1).

Suitable methods of depositing the resistive element material upon substrate 12 include, but are not limited to, sputtering physical vapor deposition, pulsed laser physical vapor deposition, plasma-enhanced physical vapor deposition, molecular beam epitaxy (thermal deposition), physical vapor deposition, chemical vapor deposition, plasma-enhanced chemical vapor deposition, laser-assisted chemical vapor deposition, partially ionized beam deposition, and the like. Other suitable deposition methods of depositing a resistive element material upon a substrate include, but are not limited to, screen printing, stenciling, dip coating, plating, spraying, and the like.

The resistive element material can be deposited as an oxide (e.g., an oxide film) and reduced to the metallic state. The resistive element material can be annealed, e.g., heated to a sufficient temperature and for a sufficient time to decompose the metal oxide to the metallic state. For example, the resistive element material can be thermal annealed, rapid thermal annealed, laser annealed, and/or electron beam annealed.

Various resistive element materials can have a range of thermal coefficient of resistivity (TCR) values. The TCR, which is generally measured in parts per million per degree temperature, is characterized by an increase in resistance for each degree increase of temperature over a given range. Materials having the highest TCR are desired such that a greater change in resistance per degree temperature can be realized compared to lower TCR values. The resistive element material can have a high thermal coefficient of resistance, i.e., greater than or equal to about 800 parts per million per degree Celsius (ppm/° C.), particularly greater than or equal to about 1,500 ppm/° C., and more particularly greater than or equal to about 2,500 ppm/° C. The resistive element material can also have a high natural resistivity (i.e., greater than or equal to about 5 micro-ohm-centimeters); is stable at high temperatures (i.e., greater than or equal to about 600° C.); and can exhibit stability over time at high temperatures (e.g., for greater than or equal to about 100 hours at about 950° C.). Suitable resistive element materials include, but are not limited to, metals and oxides of platinum, rhodium, palladium, iridium, ruthenium, gold, and mixtures and alloys comprising at least one of the foregoing materials. For example, the resistive element material can comprise platinum, which has a TCR of about 3,928 ppm/° C. It is noted that leads 14 and 16 can comprise similar materials as the resistive element material, as well as silver, nickel, chromium, and combinations comprising at least one of the forgoing.

The substrate 12 can be a ceramic material capable of withstanding the operating temperatures in which the temperature sensor 50 can be employed and, can comprise a resistance of greater than or equal to about 100,000 ohms at 1,000° C. to reduce the possible temperature sensor 50 error. Without being bound by theory, it is noted that if the resistivity of the substrate 12 is lower than about 100,000 ohms at 1,000° C., electronic noise can cause the temperature sensor 50 to report significantly erroneous sensor outputs.

In various embodiments, the substrate 12 can comprise aluminum oxide (Al₂O₃), silicon oxide (SiO₂), titanium oxide (TiO₂), zirconium oxide (ZrO₂), or a combination comprising at least one of the foregoing, as well as other dielectric materials. For example, the substrate 12 can comprise mixed oxides such as mullite (3Al₂O₃-2SiO₂), lanthanum aluminate (LaAlO₃), zirconium-aluminum oxide (ZrO₂—Al₂O₃), yttrium-zirconium-aluminum oxide (Y₂O₃—ZrO₂—Al₂O₃), fused silica (SiO₂), and the like.

A glass frit can also be added to the substrate 12 as a sintering aid for densifying alumina materials. The glass frit can comprise alumina (Al₂O₃), silica (SiO₂) and other M⁺³ valent oxides e.g., such as scandia, Sc⁺³(Sc₂O₃), yttria Y⁺³(Y₂O₃), lanthana La⁺³(La₂O₃) and boria B⁺³(B₂O₃).

The substrate 12 can be formed by any suitable process, e.g., die pressing, roll compaction, tape casting techniques, and the like. The substrate 12 can have a thickness sufficient to provide mechanical strength to the temperature sensor 50 and support the resistive element material. For example, the substrate 12 can have a thickness of about 50 micrometers to about 2,000 micrometers. In various embodiments, the substrate 12 can have a thickness of about 50 micrometers to about 800 micrometers, particularly a thickness of about 150 micrometers to about 450 micrometers, and more particularly a thickness of about 250 micrometers to about 350 micrometers. The substrate 12 can be made from tape-cast layers that have been laminated at a temperature, pressure, and for a period of time sufficient to bond the various layers together and to eliminate any void spaces therebetween. For example, a pre-fired (pre-heated) substrate can be isostatically laminated for about 1 minute to about 30 minutes, at temperatures of about 25° C. to about 125° C. and at pressures of about 400 pounds per square inch (psi) (about 2,758 kPa) to about 4,500 psi (31,026 kPa). The substrate 12 can be heated to densification, i.e., heated to a temperature to remove organics to less than about 1 wt. %, based on the total weight of the sintered substrate.

As briefly mentioned above, one embodiment of making the resistive element 10 can comprise laser ablation of the resistive element material such that a pathway cut into the resistive element material can expose the substrate 12. Without being bound by theory, lasers can be particularly attractive as the trimming device, because a large amount of energy can be focused on a very small area and manipulation of the laser operating parameters allowing the melt depth to be controlled. Suitable laser devices for ablation of the resistive element material include Nd: YAG laser, CO₂ laser, high-powered diode laser, and the like. The laser can be a continuous wave or pulsed laser. More particularly, the laser can be pulsed in the nanosecond (ns) range or faster. For example, a laser pulse energy of greater than or equal to about 10 millijoules per square centimeter (mJ/cm²) per pulse can be employed for vaporization of the resistive element material. The laser power density (energy per area) can be selected to be close to the ablation threshold of the resistive element material. The irradiation time can be sufficient to vaporize the resistive element material and/or substrate material.

Having formed the resistive element 10 (a more detailed illustration of a resistive element 110, which has been trimmed, is illustrated in FIG. 2), a protective coating 24 can be applied to the resistive element 10 by any suitable method. For example, the protective coating 24 can be disposed, e.g., by glass sealing a cover plate (FIG. 1), plasma spraying, thick film deposition, and the like. In an exemplary embodiment, the protective coating can be disposed on the resistive element 10 by plasma spraying.

The materials for the protective coating 24 can be selected to prevent contaminants, e.g., elements that change the resistance of the resistive element (such as sodium, calcium, magnesium, zinc, iron, copper, lead, chromium, manganese, molybdenum, vanadium, and the like) from permeating the protective coating 24 and interfering with the operation of the resistive element 10. More particularly, the protective coating 24 can comprise a material suitable for use in a high temperature environment (e.g., temperatures greater than or equal to 600° C.) and capable of preventing metal ions and/or other contaminants from being disposed in physical communication with the resistive element 10. Suitable materials include, but are not limited to, those materials discussed above in relation to the substrate 12. More particularly, suitable materials for the protective coating 24 include ions that do not react with the resistive element 10 at exhaust operating temperatures of less than or equal to about 1,200° C., e.g., M⁺³ and M⁺⁴ elements, wherein M denotes a metal element (e.g., gallium, cerium, silicon, zirconium, aluminum, scandium, yttrium, lanthanum, boron, and the like, as well as combinations comprising at least one of the foregoing). More particularly, suitable materials include aluminum oxide (Al₂O₃), scandium oxide (Sc₂O₃), and the like.

The protective coating 24 further comprises a porosity-sealing (sealant) component, which can be adhesively bound to the protective coating material. In other words, without being bound by theory, the porosity-sealing component does not need to be chemically bonded to the protective coating material in order to provide the desired properties in the protective coating 24. Further, due to the repeated heating and cooling cycling that the temperature sensor 50 can encounter during operation, the porosity-sealing component can be primarily amorphous at temperatures less than or equal to about 1,200° C.

For example, the porosity-sealing component can be selected to reduce the ability of contaminants to migrate through the protective coating 24, to increase the abrasion and erosion wear resistance of the protective coating 24, and the like. The porosity-sealing component can act to fill the void space (e.g., porosity) in the protective coating 24, thereby preventing/mitigating metal cations and other contaminants from being placed in physical communication with the resistive element 10. More particularly, the porosity-sealing component can substantially close the open porosity and cracks such that pathways through the protective coating material. For example, a protective coating 24 with a porosity-sealing component can comprise a porosity of 0.0% to about 3.0%, more particularly a porosity of 0.0% to about 0.3%. For illustrative purposes, a protective coating without the porosity-sealing component can comprise a porosity of about greater than or equal to 7.0%, more particularly 7.0% to 30%.

The porosity-sealing component can comprise a material that is suitable for use in a high temperature environment, is compatible with the protective coating material, and is capable of preventing metal ions and/or other contaminants including oxygen from being disposed in physical communication with the resistive element 10. Suitable materials include, but are not limited to, materials comprising a phosphate. The porosity-sealing component can be a M⁺³ and M⁺⁴ metal phosphate. For example, M can include aluminum, gallium, lanthanum, cerium, boron, scandium, yttrium, zirconium, and the like, as well as mixtures comprising at least one of the foregoing metals, with aluminum (Al⁺³ ) being particularly desirable. For example, the porosity-sealing component can include, but is not limited to, aluminum phosphate, zirconium phosphate, lanthanum phosphate, scandium phosphate, yttrium phosphate, boron phosphate, and combinations comprising at least one of the foregoing. In an exemplary embodiment, the porosity-sealing component can be present in amount sufficient to impart the desired sealing/contaminant barrier properties to the protective coating 24. Without being bound by theory, aluminum phosphate is particularly desirable, as it is chemically inert with the ceramic materials that can be used in the protective coating 24, including alumina and zirconia.

Additionally, it is noted that zirconium phosphate can possess the following advantageous characteristics: (1) density of about 2.83 g/cc; (2) a thermal conductivity value of about 6.2 BTU-in/hr-ft²-° F.; (3) the ability to withstand a maximum service temperature value of about 2,800° F. (1,538° C.); and (4) ultra high thermal shock resistance such that it can be heated or cooled at approximately 2,000° C. per minute without experiencing thermal shock. It is also resistant, under both basic and acidic conditions, to corrosive materials such as rare earth elements, alkaline earth elements, transition metal oxides, and precious metal salts, as well as compositions containing nitrogen oxides and sulfur oxides.

Suitable zirconium sources generally include zirconium dioxide, zirconium oxychloride, zirconium tert-butoxide, zirconium ethoxide, zirconium isopropoxide, colloidal zirconium oxide, and the like, with colloidal zirconium oxide, zirconium isopropoxide, and zirconium oxychloride being particularly desirable; with zirconium isopropoxide and zirconium oxychloride even more desirable; and zirconium oxychloride being most desirable.

Suitable phosphate sources generally include phosphoric acid, ammonium dihydrogen phosphate, diammonium hydrogen phosphate, triammonium phosphate, ammonium phosphate, phosphate ester, and the like; with triammonium phosphate, diammonium hydrogen phosphate, and ammonium dihydrogen phosphate being particularly desirable; with diammonium hydrogen phosphate and ammonium dihydrogen phosphate even more desirable; and with ammonium dihydrogen phosphate being most desirable.

Suitable aluminum sources generally include aluminum oxide, aluminum hydroxide boehmite and pseudoboehmite, aluminum methoxide, aluminum n-butoxide, aluminum ethoxide, aluminum isopropoxide, and the like; with aluminum ethoxide, aluminum isopropoxide, and aluminum hydroxide being particularly desirable; with aluminum isopropoxide and aluminum hydroxide even more desirable; and with aluminum hydroxide being most desirable.

Suitable lanthanum compounds for introduction of the rare earth component include lanthanum acetate, lanthanum citrate, lanthanum salicylate, lanthanum carbonate, lanthanum hydroxide, lanthanum oxide, and the like; with lanthanum acetate, lanthanum oxylate, and lanthanum hydroxide being particularly desirable; with lanthanum oxylate and lanthanum hydroxide even more desirable; and with lanthanum hydroxide being most desirable.

The porosity-sealing component can be applied to the protective coating by any suitable deposition method such that the porosity-sealing component can seal the pores of the protective coating. For example, the porosity-sealing component can be in the form of a solution, e.g., a phosphate solution, and can be wash coated, imbibed, impregnated, physisorbed, chemisorbed, precipitated, coated, sprayed, painted, or otherwise applied to the protective coating material. Excess phosphate solution can be removed, e.g., via a vacuum, and the substrate 12 with the protective coating 24 comprising the porosity sealing component can be calcined.

In an embodiment, the porosity-sealing component can be applied to the protective coating material by spraying an aluminum phosphate solution comprising about 26.0 atomic percent (at. %) aluminum and 74.0 at. % phosphorus, which refers to the metaphosphates Al(PO₃)₃. The porosity-sealing component can comprise greater than or equal to about 75 at. % phosphate, with about 75 at. % to about 80 at. % being particularly desirable, based upon the total weight of the calcined porosity-sealing component. The protective coating 24 with a porosity-sealing component can comprise a thickness of about 200 nanometers (nm) to about 20,000 nm, more particularly a thickness of about 500 nm to about 3000 nm being particularly desirable.

Optionally, after applying the porosity-sealing component to the protective coating 24, the temperature sensor 50 can be de-aired, which can be achieved by placing the porosity-sealed temperature sensor 50 in a vacuum environment for a sufficient time to remove air from the protective coating 24 (e.g., less than or equal to about 3 minutes). This allows air trapped in the protective coating 24 to be removed and replaced with porosity-sealing component. The temperature sensor 50 comprising the protective coating 24 with the porosity-sealing component can be dried and calcined (e.g., at a temperature of about 300° C. to about 500° C.) and further sintered (e.g., at a temperature greater than or equal to about 1050° C.). The resulting condensed metal phosphate can be primarily in the amorphous phase. Additionally, it is noted that other material(s) can be included in the protective coating 24. These other materials can be selected to enhance various properties of the protective coating 24. The mixed coatings can have improved resistance to developing cracks, to oxidation, and to corrosion compared to un-mixed coatings. These additional materials can be co-vaporized and co-deposited with the ceramic material (e.g., aluminum oxide). Additive materials include, but is not limited to, yttrium, lanthanum, boron, silicon, zirconium, and the like, as well as combinations comprising at least one of the foregoing.

In various embodiments, as briefly mentioned above, the protective coating 24 can be in the form of a cover plate (FIG. 1). For example, a ceramic layer can be disposed over the resistive element 10. The protective coating 24 comprising the porosity-sealing component can be disposed in the form of a plate, which can be glass sealed by applying a glass bead on the substrate at least at the sensing end 18 of the temperature sensor 50, wherein the glass bead does not touch resistive element 10. The assembly comprising protective coating 24 (cover plate) can then be fired at a temperature and for a period of time sufficient to melt the glass and attach the cover plate onto the substrate 12.

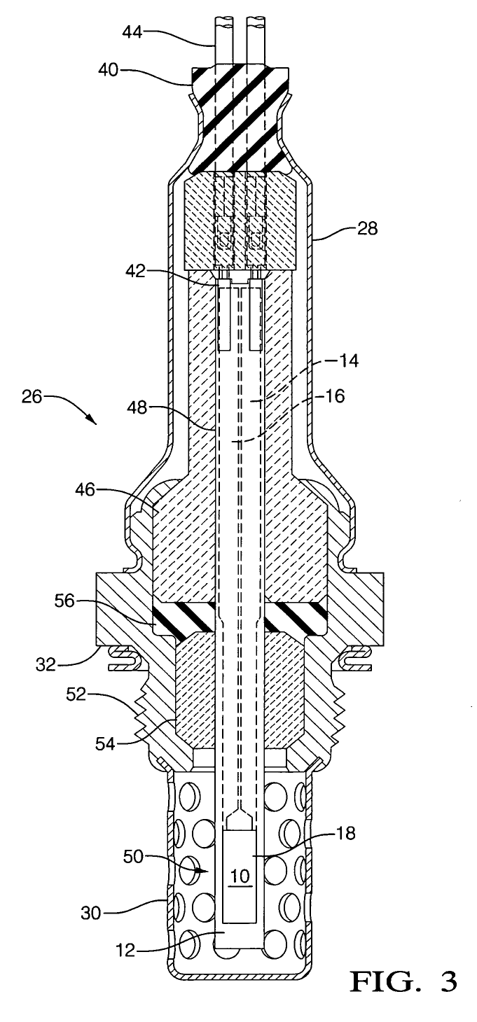

To allow the temperature sensor 50 to be used in measuring a temperature of a gas, the temperature sensor 50 can be disposed within a package to produce a packaged temperature sensor 26. Referring to FIG. 3, temperature sensor 50 can be disposed within a housing structure generally formed of an upper shield 28, a lower shield 30, and a shell 32. A plug 40 and a portion of temperature sensor 50 can be disposed within the upper shield 28. Terminals 42 can be in physical communication with external pads, (e.g., using spring terminals) to provide electrical connection between electrical wires 44, and temperature sensor 50. The use of spring terminals disposed on the end of the temperature sensor 50 can also assist in securely maintaining electrical communication therewith. The inner insulator 46 can be disposed within upper shield 28 comprising a centrally located annular opening 48 sized to allow insertion of temperature sensor 50 therethrough.

Shell 32 can comprise a body portion that can optionally be shaped to accommodate a wrench or other tool for tightening a threaded portion 52 into a mount for an exhaust pipe or other component to enable the sensing end 18 of temperature sensor 50 to be located within a flow of gas to be sensed (e.g., the measurement of an exhaust gas temperature). Shell 32 can be disposed in physical communication with upper shield 28 by crimping and the like during the assembly process. Accordingly, shell 32 can retain inner insulator 46 in a compressive force engagement. Also disposed with shell 32 can be a lower insulator 54 through which sensing end 18 of temperature sensor 50 can be disposed. Disposed between inner insulator 46 and lower insulator 54 can be a layer of inert sealing material 56 (e.g., talc, magnesium oxide, and the like).

As briefly noted above, a protective coating comprising a porosity-sealing component can be employed in applications other than in a temperature sensor. For example, the protective coating as disclosed herein can be employed in any device comprising a ceramic substrate and a resistive element disposed on the substrate, e.g., a ceramic heater. Suitable materials for the substrate can include, but are not limited to, those materials listed above with regards to the substrate employed for the temperature sensor. Suitable materials for the resistive element can include, but are not limited to, the resistive element materials discussed above. A protective coating comprising the porosity-sealing component as disclosed herein can then be disposed in physical communication with the resistive element to reduce/eliminate contaminants from migrating to the resistive element.

### EXAMPLE

In this example, a temperature sensor (Sensor 1) comprising a substrate, a resistive element, and a protective coating was dipped into an aluminum phosphate solution comprising 22.5 at. % aluminum (Al(NO₃)₃9H₂O) and 77.5 at. % phosphorus (H₃PO₄). The aqueous solution contained 5 vol.% ethanol based upon the total volume of the solution. The coated temperature sensor was heated in a standard home microwave (2.5 GHz) for 150 seconds. The microwave treated temperature sensor was heat-treated to 800° C. at a rate of 5° C. per minute, then allowed to cool to room temperature. Amorphous aluminum metaphosphate Al(PO₃)₃ formed as the porosity-sealing component. Crystalline AlPO₄ formed at the protective coating-porosity sealing interface.

Sensor 1 was compared to a second temperature sensor (Sensor 2) comprising only a protective coating (i.e., same protective coating as (Sensor 1), but no porosity-sealing component). An accelerated dynamometer engine test was run (referred to herein as a “hypercode 13” test), wherein each 50 hours of the test simulated about 125,000 miles of vehicle operation. More particularly, oil was directly injected into the exhaust stream, wherein the oil in the exhaust stream comprised 10 times the M⁺¹ and M⁺² detergent components ordinarily present in an exhaust stream. The temperature sensor was placed in fluid communication with the exhaust stream. It is generally noted, as engine oil contaminants migrated to the resistive element, the TCR value increased.

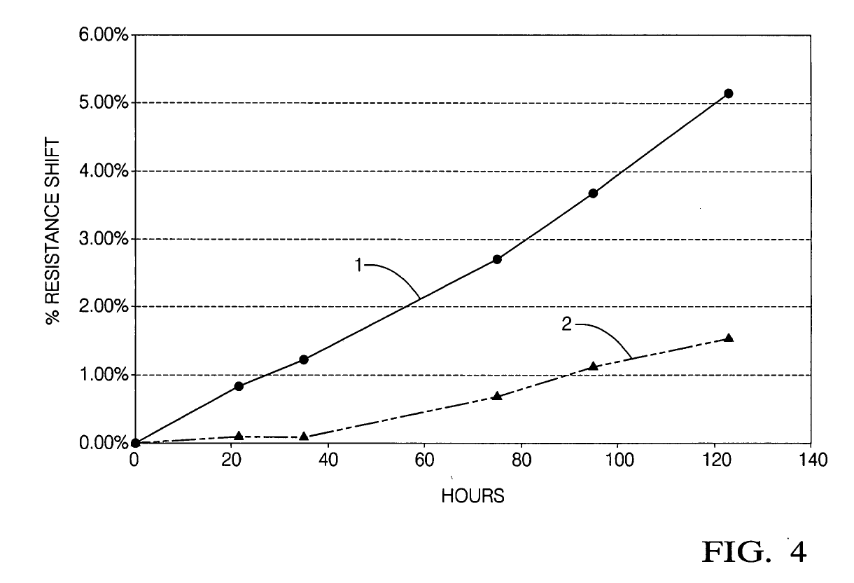

Referring now to FIG. 4, a graph was shown wherein the percent resistance shift was measured as a function of time, wherein each 50 hours simulated about 125,000 miles of vehicle operation. Line 1 represented sensor 2; and line 2 represented Sensor 1. It is noted that there was essentially no resistance shift up to 40 hours of the test for line 2, whereas there was a substantially linear increase in resistance for line 1 over the same time. Since 50 hours of hypercode 13 testing represented the average design life of a temperature sensor, the temperature sensor comprising the porosity-sealing component outperformed the temperature sensor with no porosity-sealing component. This trend was maintained at greater testing times, wherein Sensor 1 showed a smaller increase in % resistance shift at 100 hours than Sensor 2 showed at 50 hours. More particularly, Sensor 1 had a % resistance shift less than 2.0% for over 120 hours of hypercode 13 testing (about 300,000 miles of vehicle operation).

Without being bound by theory, a percent resistance shift can be attributed to M₊₁ and M⁺² contaminant migration to the resistive element. As such, the temperature sensor represented by line 2 had less M₊₁ and M⁺² contaminant migration compared to line 1.

Advantageously, the temperature sensors, ceramic devices, and the like comprising a protective coating and a porosity-sealing component, can reduce/eliminate M₊₁ and M⁺² contaminants (e.g., sodium, calcium, magnesium, zinc, iron, copper, lead, chromium, manganese, molybdenum, vanadium, and the like) from migrating to the resistive element, resistive element, and the like. For example, in various embodiments, the protective coating can form a migration-tight seal between the resistive element and the environment to be sensed. Since these M₊₁ and M⁺² contaminants can adversely affect the resistive properties of the resistive element, any reduction in the M₊₁ and M₊₂ contaminants that migrate to the resistive element can greatly increase the useful life of the temperature sensor, ceramic device, and the like. Furthermore, it is noted that the porosity-sealing component of the protective coating can reduce abrasion and erosion wear to the protective coating.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A ceramic device comprising:
a substrate;
a resistive element disposed on the substrate; and
a protective coating disposed on the resistive element, wherein the protective coating comprises a M⁺³ metal oxide, a M⁺⁴ metal oxide, or a combination comprising at least one of the foregoing, and a phosphate.

2. The ceramic device of claim 1, wherein the phosphate is an M⁺³ metal phosphate, M⁺⁴ metal phosphate, or a combination comprising at least one of the foregoing.

3. The ceramic device of claim 2, wherein the phosphate is selected from the group consisting of aluminum phosphate, scandium phosphate, yttrium phosphate, lanthanum phosphate, boron phosphate, silicon phosphate, zirconium phosphate, and combinations comprising at least one of the foregoing.

4. The ceramic device of claim 1, wherein the M⁺³ metal oxide is selected from the group consisting of aluminum oxide, scandium oxide, and combinations comprising at least one of the foregoing.

5. The ceramic device of claim 1, wherein the protective coating further comprises an additive material selected from the group consisting of yttrium, lanthanum, boron, silicon, zirconium, and combinations comprising at least one of the foregoing.

6. The ceramic device of claim 1, wherein the resistive element comprises a resistance value greater than or equal to about 200 ohms.

7. The ceramic device of claim 1, wherein the protective coating comprises a porosity of less than or equal to about 3.0%.

8. The ceramic device of claim 1, wherein the porosity is less than or equal to about 0.3%.

9. The ceramic device of claim 1, wherein the ceramic device is a temperature sensor.

10. The ceramic device of claim 1, wherein the ceramic device is a heater.

11. A ceramic device comprising:
a substrate;
a resistive element disposed on the substrate; and
a protective coating disposed on the resistive element, wherein the protective coating comprises a M⁺³ metal oxide, a M⁺⁴ metal oxide, or a combination comprising at least one of the foregoing, and a porosity-sealing component such that the protective coating comprises a porosity less than or equal to about 3.0%.

12. The ceramic device of claim 1, wherein the porosity is less than or equal to about 0.3%.

13. The ceramic device of claim 1, wherein the ceramic device is a temperature sensor.

14. A method of making a ceramic device comprising:
forming a resistive element on a substrate;
disposing a protective coating on the resistive element; and
reducing a porosity of the protective coating by applying a phosphate to the protective coating.

15. The method of claim 14, wherein after applying the phosphate, the porosity is less than or equal to about 3.0%

16. The method of claim 15, wherein the porosity is less than or equal to about 0.3%.

17. The method of claim 14, wherein the ceramic device is a temperature sensor.
